(19) United States
(12) Patent Application Publication
(10) Pub. No.: US 2014/0354810 A1
(43) Pub. Date: Dec. 4, 2014

(54) CONTAINER DATA CENTER MOVING SYSTEM

(71) Applicant: HON HAI PRECISION INDUSTRY CO., LTD., New Taipei (TW)

(72) Inventors: CHO-HAO WANG, New Taipei (TW); CHIH-HUANG WU, New Taipei (TW)

(73) Assignee: HON HAI PRECISION INDUSTRY CO., LTD., New Taipei (TW)

(21) Appl. No.: 14/060,591

(22) Filed: Oct. 22, 2013

(30) Foreign Application Priority Data
May 30, 2013 (TW) 102119057

(51) Int. Cl. G06K 9/00; B60R 1/00

(52) U.S. Cl. CPC G06K 9/00805; B60R 1/00
USPC 348/148

(57) ABSTRACT

A container data center moving system employed to a container data center during transportation includes a photo processing module, a calculating module, a determining module and a control module. The photo processing module obtains moving state of the container data center and other moving objects on a road according to a photo of the road. The present moving state includes movement directions, movement speeds and movement accelerations. The calculating module determines whether the container data center is likely to collide with any moving object under their present moving states and evaluates a time length to a collision likely happened between the container data center and any moving object. The determining module determines whether the time length is less than a preset value. The control module stores date of the container data center in running to a data backup module if the time length is less than the preset value.

### BACKGROUND

1. Technical Field

The present disclosure relates to moving container data centers, especially relates to a container data center moving system.

2. Description of Related Art

Data servers are installed in a container data center to be moved from a place to another place by a vehicle. The vehicle may be involved in an accident during transportation, which may cause losses to data running in the data server.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the views.

FIG. 1 is a block diagram of a container data center moving system.

FIG. 2 is a block diagram of a power system for a moving container data center.

### DETAILED DESCRIPTION

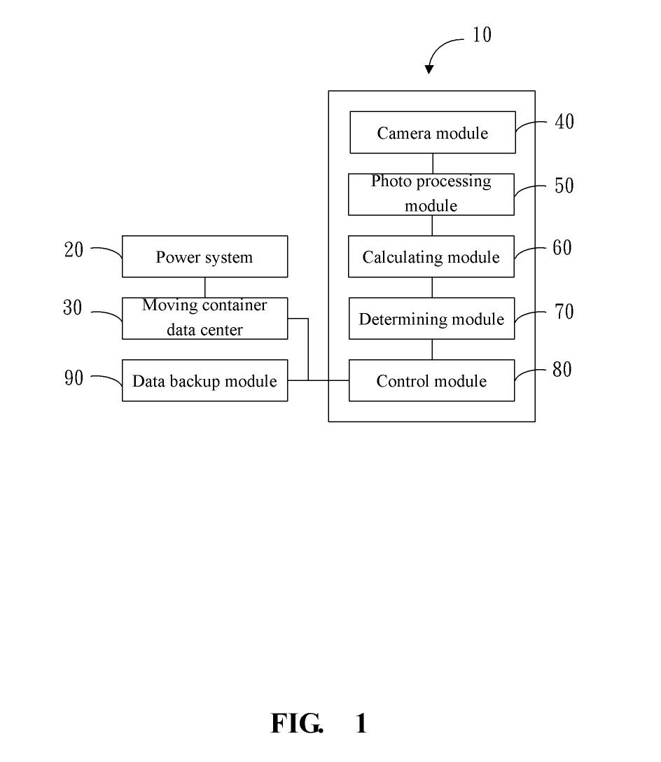

FIG. 1 shows a block diagram of a container data center moving system 10. The container data center moving system 10 is employed to a moving container data center 30. The container data center moving system 10 includes a camera module 40, a photo processing module 50, a calculating module 60, a determining module 70 and a control module 80.

The moving container data center 30 is powered by a power system 20. The camera module 90 is configured to capture images of ambient scenes of the moving container data center 30 on a road where the moving container data center 30 is located. The photo processing module 50 is configured to determine current moving states of the moving container data center 30 and other moving objects according to the images captured by the camera module 40. The current moving state of a moving object includes movement directions, movement speeds and movement accelerations of the moving object. In this exemplary embodiment, the camera module 40 includes four cameras respectively positioned at four corners of the moving container data center 30 to capture images of the road surrounding the moving container data center 30.

The calculating module 60 is configured to determine whether the moving container data center 30 is likely to collide with any moving object under their current moving state and evaluate a time duration for the happening of the likely collision. The determining module 70 is configured to determine whether the time duration is less than a preset value. The control module 80 is configured to store data of the moving container data center 30 in running to a data backup module 90 if the time duration is less than the preset value. In this exemplary embodiment, the data backup module 90 is arranged in the moving container data center 30. In another exemplary embodiment, the data backup module 90 is arranged in a remote server communicating with the moving container data center 30.

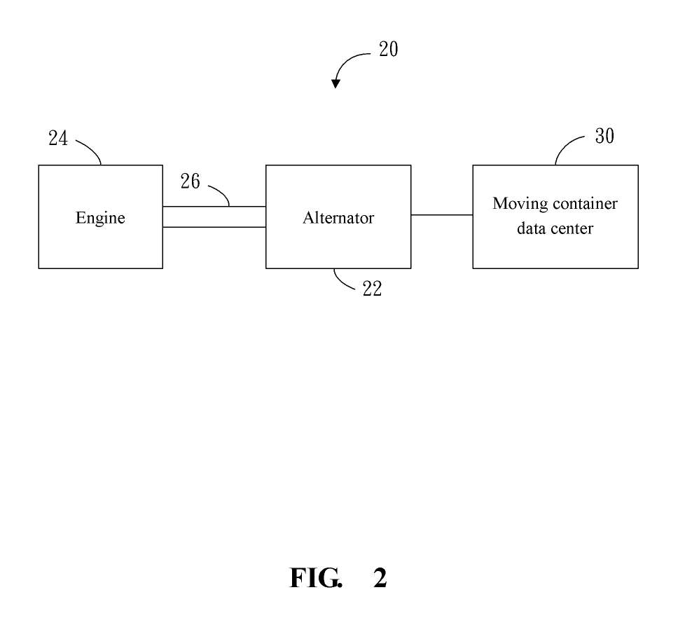

FIG. 2 shows a block diagram of the power system 20 for the container data center 30. The power system 20 includes an alternator 22. The alternator 22 is configured to connect to an output shaft 26 of an engine 24 of a vehicle carrying the moving container data center 30 and power the moving container data center 30.

The container data center moving system 10 disclosed can store the data to the data backup module 90 before the vehicle has an accident. Thus, the data is safe even if the vehicle has an accident.

It is to be understood, however, that even though numerous characteristics and advantages of the present disclosure have been set fourth in the foregoing description, together with details of the structure and function of the present disclosure, the present disclosure is illustrative only, and changes may be made in detail, especially in matters of shape, size, and arrangement of parts within the principles of the present disclosure to the full extent indicated by the broad general meaning of the terms in which the appended claims are expressed.

What is claimed is:

1. A container data center moving system employed to a moving container data center, comprising:
a camera module;
a photo processing module configured to determine current moving states of the moving container data center and other moving objects around the moving container data center on a road according to images of ambient scenes of the moving container data center on the road captured by the camera module, the current moving states comprising movement directions, movement speeds and movement accelerations of the container data center and the other moving objects;
a calculating module configured to determine whether the container data center is likely to collide with any moving object under their current moving states and evaluate a time duration remaining for a collision likely happened between the container data center and any moving object;
a determining module configured to determine whether the time duration is less than a preset value;
a control module configured to store data of the moving container data center in running to a data backup module if the time duration is less than the preset value.

2. The container data center moving system as described in claim 1, wherein the camera module comprises four cameras respectively positioned at four corners of the moving container data center to capture images of the ambient scenes surrounding the moving container data center.

3. The container data center moving system as described in claim 1, wherein the data backup module is arranged in the container data center.

4. The container data center moving system as described in claim 1, wherein the data backup module is arranged in a separate remote server communicating with the container data center.

5. The container data center moving system as described in claim 1, wherein container data center is powered by a power system, the power system comprises an alternator, the alternator is coupled to an output shaft of an engine of a vehicle carrying the container data center.
